(19) United States
(12) Patent Application Publication
(10) Pub. No.: US 2016/0302233 A1
(43) Pub. Date: Oct. 13, 2016

(54) ENHANCED RANDOM ACCESS PROCEDURE

(71) Applicant: QUALCOMM Incorporated, San Diego, CA (US)

(72) Inventors: Rajesh Gopala Krishnan, Hyderabad (IN); Sitaramanjaneyulu Kanamarlapudi, San Diego, CA (US); Guruvayurappan Vasudevan, Hyderabad (IN); Dhananjaya Sarma Ponukumati, Hyderabad (IN)

(21) Appl. No.: 14/829,455

(22) Filed: Aug. 18, 2015

Related U.S. Application Data
(60) Provisional application No. 62/145,386, filed on Apr. 9, 2015.

(51) Int. Cl. H04W 74/08

(52) U.S. Cl. CPC H04W 74/0833

(57) ABSTRACT

Aspects of random access channel preamble transmission include transmitting a number of random access preamble transmissions in response to receiving a command to initiate a physical random access procedure, determining that the number of random access preamble transmissions meets an unacknowledged preamble transmission number threshold, determining whether a downlink channel quality exceeds a downlink channel quality threshold, and suspending the transmitting of subsequent random access preamble transmissions for a transmit hold duration.

### CLAIM OF PRIORITY UNDER 35 U.S.C. §119

The present Application for Patent claims the benefit of Provisional Application No. 62/145,386, filed Apr. 9, 2015, which is assigned to the assignee hereof and hereby expressly incorporated in its entirety by reference herein.

### BACKGROUND

Aspects of the present disclosure relate generally to wireless communication systems, and more particularly to an enhanced random access procedure, for example, related to transmitting bursty data traffic on a shared common channel.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

For efficient spectrum utilization, such as when a user equipment (UE) has relatively small amounts of bursty data traffic to transmit, the UE may be in a state without a dedicated physical channel to the network, such as a CELL_FACH (forward access channel) state. In this state, since the UE is not assigned any dedicated channels, data transmission/reception occur through shared/common transport channels, such as FACH (in downlink) and random access channel (RACH) (in uplink). The RACH is a common transport channel in the uplink and is mapped onto physical channels (PRACHs). The network may broadcast the physical channel information for the PRACH in a system information block, and cell parameters such as uplink interference levels used for open loop power control may be broadcasted in another system information block. A RACH transmission on the uplink includes a preamble part and a data part. The UE transmits the preamble at an initial power level and then waits for an access indicator sent by the network on the downlink (e.g., on an Acquisition Indicator Channel (AICH)) that may include a positive acknowledgment (ACK), a negative acknowledgment, or no acknowledgment. The RACH data is sent by the UE in response to a positive acknowledgement. For a negative acknowledgment, the UE backs off for a period to attempt random access again at a later time. With no acknowledgment, the UE resends the preambles at increasing power levels until a maximum allowable number of preambles have been attempted (e.g., a preamble retransmission counter reaching a value of Preamble Retransmission Max in accordance with 3GPP specification) or a maximum transmit power level is reached. Because this is an open loop power control, during the RACH procedure, no feedback from the network is provided for indicating the power level for transmitting the random access preambles. Only the initial transmit power is provided by the network as described above.

In a dedicated state, no uplink transmission starts until the downlink is synchronized, e.g., comes IN_SYNC, which ensures that uplink resources are well managed. In CELL_FACH state, however, the random access procedure is independent of downlink channel quality. Since the acknowledgement (ACK) reception (e.g., on the AICH) or the decoding of the AICH are acknowledged immediately within a short period and also dependent on downlink channel quality, the UE may spend a lot of power on futile random access preambles with no possibility of ACK during AICH decode at certain poor RF/channel condition and starve the common resources of other UE's in the vicinity/cell. This problem may arise more frequently in poorly planned wireless networks that fail to provide adequate cell coverage. For example, the downlink channel condition may be poor, and the UE does not have RF fingers in lock and there is no proper energy decoded in a downlink AICH from the network. The UE will continuously attempt preamble transmissions sequentially at increasing transmit power levels so long as data is to be sent, regardless of downlink condition. As a result, the UE will suffer degraded battery performance with the multiple unsuccessful RACH transmission attempts. Moreover, these futile random access preamble transmission attempts add interference to the network and potentially may cause collisions with other signals on the RACH.

Therefore, improvements in the UE RACH procedure during a CELL_FACH state are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the disclosure relates to a user equipment (UE) controlling uplink transmissions on a random access channel.

For instance, in an aspect, this disclosure provides a method of transmitting data in a user equipment, including transmitting, via a transceiver, a number of random access preamble transmissions in response to receiving a command to initiate a physical random access procedure, wherein the number of random access preamble transmissions have not been acknowledged. Further, the method includes determining, via a processor, that the number of random access preamble transmissions meets an unacknowledged preamble transmission number threshold, and determining, via the processor, whether a downlink channel quality measurement meets a downlink channel quality threshold in response to determining that the number of random access preamble transmissions meets the preamble transmission number threshold. Further, the method includes suspending, at the transceiver, the transmitting of subsequent random access preamble transmissions for a transmit hold duration in response to determining failure of the downlink channel quality measurement to meet the downlink channel quality threshold. Optionally, the method may further include sending one or more status messages to a higher protocol layer in response to the failure of the downlink channel quality measurement to meet the downlink channel quality threshold during the transmit hold duration, wherein the one or more status messages indicate that no acknowledgement has been received for the corresponding one or more of subsequent random access preamble transmissions that would have been transmitted during the transmit hold duration.

In another aspect, this disclosure provides a user equipment including a processor coupled to a memory; and a transceiver coupled to the processor, the transceiver being configured to transmit a number of random access preamble transmissions in response to receiving a command to initiate a physical random access procedure, wherein the number of random access preamble transmissions have not been acknowledged. Further, the processor and memory are configured to determine that the number of random access preamble transmissions meets an unacknowledged preamble transmission number threshold, and determine whether a downlink channel quality measurement meets a downlink channel quality threshold in response to determining that the number of random access preamble transmissions meets the preamble transmission number threshold. Further, the transceiver is configured to suspend the transmitting of subsequent random access preamble transmissions for a transmit hold duration in response to the processor and memory determining failure of the downlink channel quality measurement to meet the downlink channel quality threshold.

In a another aspect, a computer-readable medium is provided which stores computer executable code for controlling uplink transmissions on an enhanced dedicated channel in wireless communications, including code for transmitting a number of random access preamble transmissions in response to receiving a command to initiate a physical random access procedure, wherein the number of random access preamble transmissions have not been acknowledged. Further, the computer readable medium includes code for determining that the number of random access preamble transmissions meets an unacknowledged preamble transmission number threshold; code for determining whether a downlink channel quality measurement meets a downlink channel quality threshold in response to determining that the number of random access preamble transmissions meet the preamble transmission number threshold; and code for suspending the transmitting of subsequent random access preamble transmissions for a transmit hold duration in response to determining failure of the downlink channel quality measurement to meet the downlink channel quality threshold.

These and other aspects of the disclosure will become more fully understood upon a review of the detailed description, which follows.

### BRIEF DESCRIPTION OF THE DRAWINGS

The accompanying drawings are presented to aid in the description of various aspects of the disclosure and are provided solely for illustration of the aspects and not limitation thereof. The drawings include like reference numbers for like elements.

FIG. 1 is a schematic diagram of a communication network including a user equipment (UE) having an aspect of a random access channel (RACH) process for managing transmission of random access preambles in a forward access channel (FACH) state.

FIG. 2 is a graphical illustration of an aspect of the control thresholds used by the UE of FIG. 1 for managing the transmission of random access preambles.

FIG. 3 is a flowchart of an aspect of a method of transmitting random access preambles, which may be executed by the user equipment of FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “processor” as used herein may be hardware, firmware, and/or software, and may be divided into other processors.

The present disclosure provides for an improved RACH procedure for a UE in a FACH state (e.g., CELL FACH) after initial random access preamble transmissions are followed by no positive or negative acknowledgment indicators being received from the network, e.g., on an AICH. In this situation, for example, downlink conditions are likely so poor that acknowledgments by the network are not likely to be received at the UE for the full duration of the RACH procedure. In the aspects described herein, the UE may utilize an enhanced RACH procedure to more efficiently operate in such a situation. As described herein, the UE may initiate a PRACH procedure if there is a relatively small amount of data to transmit on the uplink, e.g., an amount of data where establishment of a dedicated channel is not justified, or allowed via a standard specification. In this case, the UE may send one or more random access preambles and not receive any positive or negative acknowledgment from the network on a downlink channel (e.g., AICH). If a threshold number (e.g., unacknowledged preamble transmission number threshold) of initial random access preamble attempts have not produced an acknowledgment, the UE may measure the quality of the downlink channel (e.g., for one or more TTIs), and determine that a minimum threshold (e.g., a downlink channel quality threshold) for decoding the acknowledgment is not satisfied. In response to determining the unfavorable downlink quality measurements (e.g., the downlink quality not meeting the downlink channel quality threshold), the UE may suspend transmission of subsequent random access preambles and correspondingly send a negative acknowledgment to the upper layer as if the network had sent a negative acknowledgements on the downlink channel (e.g., AICH) for the subsequent random access preambles. If further downlink channel quality measurements are below the threshold for a prolonged period greater than a duration threshold (e.g., a random access stop threshold), the UE may end the current RACH process. If further downlink channel quality measurements remain below the threshold, for a third durational threshold, the UE may declare the current cell not suitable to higher layers and begin a cell reselection procedure.

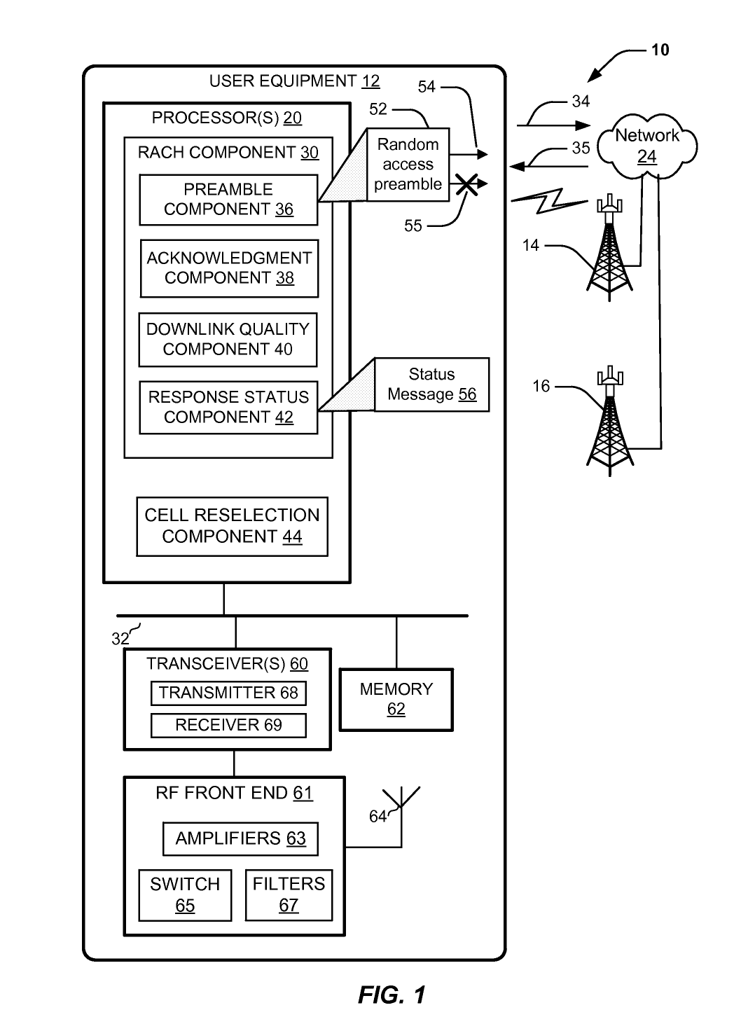

Referring to FIG. 1, in one aspect, a wireless communication system 10 includes a user equipment (UE) 12 having relatively small amounts of bursty data for uplink transmission to a network 24, one or more processors 20, and a RACH component 30 running via one or more processors 20 and/or memory 62, where operation of RACH component 30 can control transmission of random access preambles during a RACH procedure while UE 12 is in a forward access state. For instance, UE 12 may be camped on a cell serviced by base station 14 while in a CELL_FACH state, requesting access to a shared access channel, e.g., a RACH, to transmit the data to the network 24. During the RACH procedure, the UE 12 may send random access preambles on uplink 34 and monitor the downlink 35, e.g., an AICH, for acknowledgment from the network 24 that a random access preamble was received by the network 24.

According to the present aspects, the UE 12 may include one or more processors 20 coupled to a memory 62 and transceiver 60 via a bus 32. One or more processors 20 may execute various components for controlling uplink data transmission on an enhanced dedicated channel as described herein. For instance, in some aspects, the various components related to controlling uplink data transmission on an enhanced dedicated channel may be executed by a single processor, while in other aspects different ones of the components may be executed by a combination of two or more different processors. For example, in an aspect, the one or more processors 20 may include any one or any combination of a modem baseband processor, or a digital signal processor, or a transmit processor, or a transceiver processor or an application-specific integrated circuit (ASIC). In particular, the one or more processors 20 in conjunction with memory 62 may execute RACH component 30 to efficiently control random access preamble transmissions, especially, for example, in a situation where no positive or negative acknowledgements are being received in response to the random access preambles. In an aspect, the RACH component 30 may include hardware and/or software code executable by one or more processors 20 in conjunction with memory 62 for controlling RACH transmissions based on a number of unacknowledged transmissions (e.g., no positive or negative acknowledgements received). The RACH component 30 may be configured to transmit a number of random access preamble transmissions in response to receiving a command to initiate a physical random access procedure. Further, RACH component 30 may be configured to determine a number of random access preamble transmissions have not been acknowledged, and that the number of unacknowledged random access preamble transmissions meets an unacknowledged preamble transmission number threshold N_{threshold}. Further, the RACH component 30 may be configured to determine whether a downlink channel quality exceeds a downlink channel quality threshold in response to determining that the number of unacknowledged random access preamble transmissions meets the unacknowledged preamble transmission number threshold N_{threshold}. Accordingly, the RACH component 30 may be further configured to suspend the transmitting of subsequent random access preamble transmissions for a transmit hold duration T_{hold}_{_}_{threshold} in response to determining that the downlink channel quality does not meet a downlink channel quality threshold. Additionally, the RACH component 30 may be configured to send one or more status messages to a higher protocol layer in response to the suspending of the transmitting of the subsequent random access preamble transmissions, wherein the one or more status messages each indicate that no acknowledgement (e.g., no positive or negative acknowledgement) has been received for the corresponding one or more of the subsequent random access preamble transmissions that would have been transmitted during the transmit hold duration.

According to the present aspects, the RACH component 30 may include preamble component 36. In an aspect, the preamble component 36 may include hardware (e.g., one or more processor components) and/or software code executable by a processor for generating random access preambles 52 and transmitting a number of random access preamble transmissions 54 in response to receiving a command to initiate a physical random access procedure. The preamble component 36 may be further configured to suspend preamble transmissions 55 for a transmit hold duration T_{hold}_{_}_{threshold} and/or resume in response to various conditions as described below. The value of the transmit hold duration T_{hold}_{_}_{threshold} may be, for example, a current transmission time interval (TTI) and may be extended, e.g., based on continued failure of a downlink channel quality measurement to meet a downlink channel quality threshold, to a random access stop threshold, T_{RACH}_{_}_{threshold}. In an aspect, for example, random access stop threshold, T_{RACH}_{_}_{threshold}, may be a duration corresponding to less than a maximum expiration time for retransmission of preambles set (e.g., by a 3GPP standard) for the RACH procedure, or corresponding to a number of preambles to reach a maximum transmit power limit set (e.g., by a 3GPP standard) for the RACH procedure. For example, random access stop threshold, T_{RACH}_{_}_{threshold}, may be a duration corresponding to half the maximum expiration time parameter to send maximum number of preambles as set by parameter Preamble Retransmission Max according to 3GPP specifications for the RACH procedure.

Also, according to the present aspects, the RACH component 30 may include an acknowledgement component 38. In an aspect, the acknowledgement component 38 may include hardware (e.g., one or more processor components) and/or software code executable by a processor for monitoring for acknowledgements to preamble transmissions, e.g., AI's on AICH, and/or determining that the number of random access preamble transmissions that have not received a positive or negative acknowledgement meets an unacknowledged preamble transmission number threshold N_{threshold}. For example, the value of threshold N_{threshold} may be less than the maximum count limit parameter Preamble Retransmission Max according to the 3GPP specifications. For instance, the value of N_{threshold} may be set to one half the maximum count limit parameter Preamble Retransmision Max.

Additionally, according to the present aspects, the RACH component 30 may include a downlink quality component 40. In an aspect, the downlink quality component 40 may include hardware (e.g., one or more processor components) and/or software code executable by a processor for determining whether a downlink channel quality meets a downlink channel quality threshold in response to the acknowledgement component 38 determining that the number of random access preamble transmissions meets the preamble transmission number threshold N_{threshold}. The downlink quality component 40 may be further configured to determine an updated downlink channel quality during a transmit hold duration, and whether the updated downlink channel quality meets the downlink channel quality threshold. The downlink quality component 40 may send output to the preamble component 36 such that the preamble component 36 may suspend the transmitting of subsequent random access preamble transmissions for the transmit hold duration in response to the downlink quality component 40 determining that the downlink channel quality or the updated downlink channel quality does not meet a downlink channel quality threshold. If the downlink quality component 40 determines that the downlink channel quality or updated downlink channel quality meets the downlink quality threshold, then the RACH component 30 and/or preamble component 36 may continue the random access procedure, e.g., including re-initiating the transmitting of random access preambles.

Further, according to the present aspects, the RACH component 30 may include a response status component 42. In an aspect, the response status component 42 may include hardware (e.g., one or more processor components) and/or software code executable by a processor for sending one or more status messages 56 to a higher protocol layer in response to the suspending of the transmitting of the subsequent random access preamble transmissions. The one or more status messages may indicate that no acknowledgement has been received for the corresponding one or more of the subsequent random access preamble transmissions that would have been transmitted during the transmit hold duration.

According to the present aspects, the UE 12 may include a cell reselection component 44. In an aspect, the cell reselection component 44 may include hardware (e.g., one or more processor components) and/or software code executable by one or more processors 20 for initiating a cell reselection to a new cell in response to determining that the suspending of the transmitting of the subsequent random access preamble transmissions has lasted for a random access stop threshold, T_{RACH}_{_}_{threshold}. For example, cell reselection component 44 may initiate a handover from base station 14 to base station 16 upon RACH component 30 and/or the preamble component 36 determining whether suspension of subsequent random access preamble transmissions has lasted for the random access stop threshold, T_{RACH}_{_}_{threshold}. The stop threshold T_{RACH}_{_}_{threshold} may be a time value less than a normal expiration allowed by the RACH transmission procedure for UE 12 (e.g., according to a 3GPP standard). As such, the UE 12 takes advantage of the faster conclusion of the RACH procedure with a cell having a low quality downlink according to the aspects described herein and may move to a another cell sooner than it would had the failed random access preamble transmissions been permitted to run the full course, draining system resources and UE 12 resources. In an alternative aspect, the cell reselection component 44 may include hardware (e.g., one or more processor components) and/or software code executable by a separate processor different than the processor used for RACH component 30.

Moreover, in an aspect, UE 12 may include one or more transceivers 60 for receiving and transmitting radio transmissions. For instance, the one or more transceivers 60 may be configured to receive different kinds of radio signals, e.g., cellular, WiFi, Bluetooth, GPS, etc. For example, in an aspect, one or more transceivers 60 may be in communication with or connected to a radio frequency (RF) front end 61 defined by, for instance one or more power amplifiers 63, one or more band specific filters 67, and one or more antennas 64. When a downlink signal is received by UE 12, such as but not limited to acknowledgement message in response to an uplink transmission, antenna 64 converts radio waves of the received signal to an electrical signal. Antenna switch 65 may be a duplex switch that may selectively operate to select either a transmit path or a receive path for the signal (e.g., to select a receive path in this example). Filters 67 perform frequency filtering on the signal to obtain the desired frequency band. One or more transceivers 60 may perform a downconversion of the received signal from RF front end 61, and may split the signal into in-phase and quadrature (I and Q) components. Amplifiers 63 may include a first amplifier to boost the filtered signal initially received from filters 67, and a second amplifier for boosting the I and Q components. The I and Q components may then be converted to a digital format and demodulated by transceiver 60. The I and Q components of received signal leaving one or more transceivers 60 may be a baseband signal that may be then further processed by the one or more processors 20. Although one or more transceivers 60 is shown as a separate component from one or more processors 20, it should be understood that in some implementations, one or more transceivers 60 may be included as a part of one or more processors 20.

For example, one or more transceivers 60 may include a transmitter 68 and may include hardware and/or software code executable by one or more processors 20 for transmitting RACH transmissions, such as random access preamble transmissions 54. Additionally, for example, transceiver 60 may also include a receiver 69 for receiving acknowledgements, such as AIs on the AICH. One or more transceivers 60 may include a transmitter 68 for sending a signal for cell reselection upon one or more processor 20 determining that current cell is not suitable based on downlink channel quality measurements. The RACH component 30 may be configured to control RACH transmissions via one or more transceiver(s) 60. For example, RACH component 30 may include and execute communication protocols and/or manage other standards-specific communication procedures using protocol-specific and/or standards-specific instructions and/or subscription-specific configuration information that allow communications with the network 24 for RACH transmissions and alternatively a second network 26 upon cell reselection.

The one or more processors 20 shown in FIG. 1 may be a single processor, or may be implemented as multiple processors on which the components may operate.

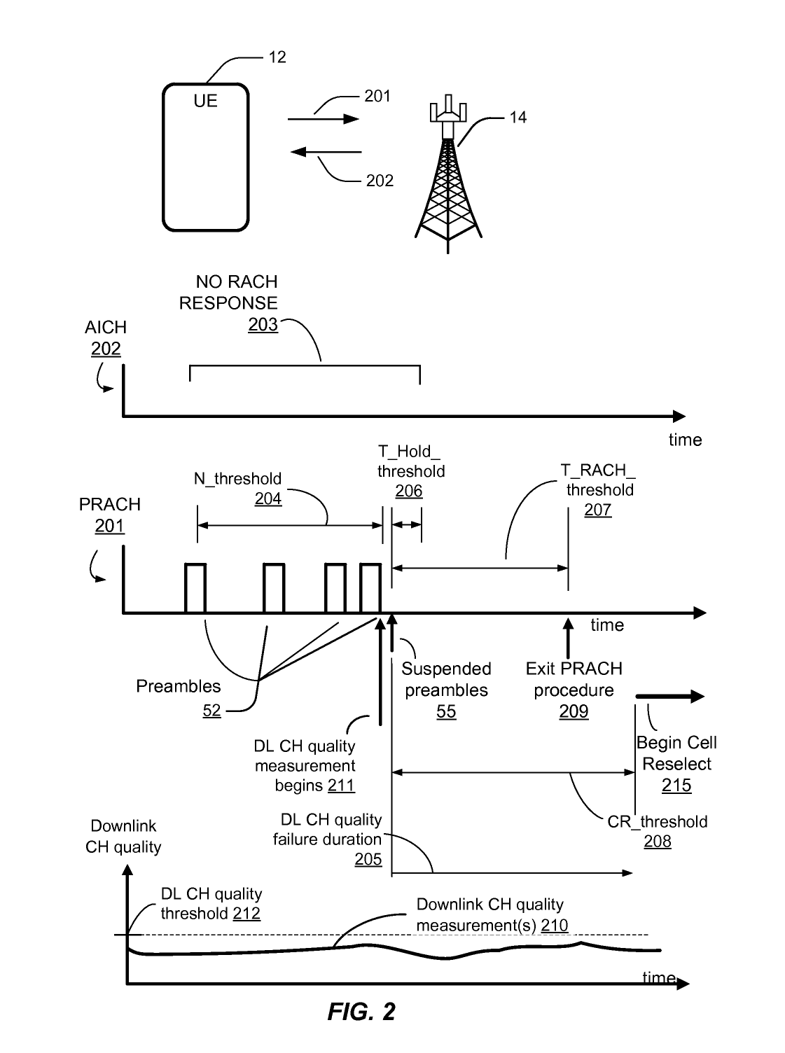

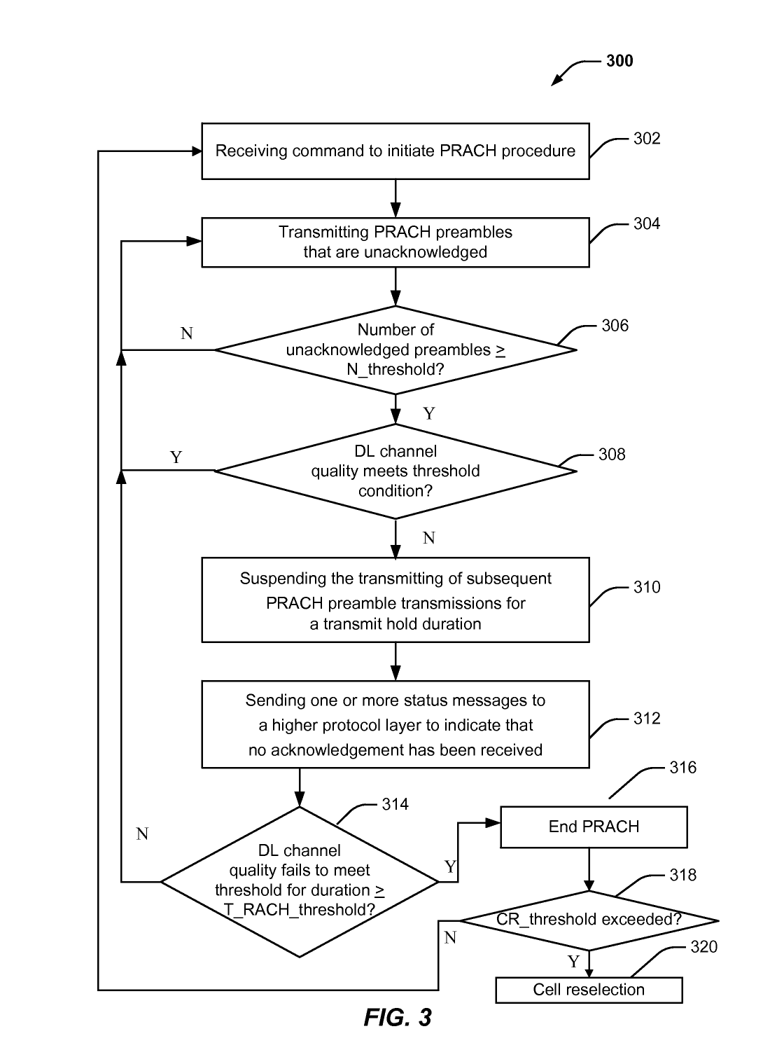

Referring to FIG. 2 and FIG. 3, in an operational aspect, a UE such as UE 12 (FIG. 1) may include one or more processors 20 to perform one aspect of a method 300 for random access preamble transmission by UE 12 during a forward access state, as graphically illustrated in FIG. 2. In particular, FIG. 2 includes an example representation of PRACH channel 201 over time, an AICH channel 202 over time, a downlink channel quality measurement 210 over time, and additional features (e.g., random access preambles 52, various threshold and durations) discussed below with respect to method 300. While, for purposes of simplicity of explanation, the method is shown and described as a series of acts, it is to be understood and appreciated that the method is not limited by the order of acts, as some acts may, in accordance with one or more embodiments, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 302, the method 300 may include receiving a command to initiate a physical random access procedure. For example, in an aspect, UE 12 and/or RACH component 30 in association with one or more processors 20 and memory 62 may receive a command from a medium access control (MAC) layer after a radio link control (RLC) layer has indicated to the MAC layer that there is data to be transmitted, e.g., based on a buffer occupancy value. For example, per 3GPP TS25.214, section 6.1: “The physical random access procedure described in this subclause is initiated upon request from the MAC sublayer (see, TS 25.321, sections 11, 11.1, and 11.2).” The physical random access procedure may be triggered by the UE 12 being in a CELL FACH state instead of a dedicated channel establishment when the amount of data occupying the buffer is insufficient to trigger a CELL DCH state.

In an aspect, at block 304, the method 300 may include transmitting a number of random access preambles in response to receiving the command at block 302, where the number of random access preamble transmissions has not been acknowledged. For example, in an aspect, UE 12 and/or RACH component 30 and/or preamble component 36 in association with one or more processors 20 and memory 62 may transmit one or more random access preambles 52 without UE 12 and/or RACH component 30 and/or acknowledgment component 38 receiving an acknowledgment from the network 24 on the AICH. Referring to FIG. 2, for example, UE 12 may send random access preambles 52 on PRACH 201 to base station 14. As shown in FIG. 2, for each of the random access preambles 52, UE 12 does not receive a RACH response 203 on AICH 202. To implement this process at block 304, one or more processors 20 may operate in conjunction with memory 62 and transmitter 68 of one or more transceivers 60 to perform the PRACH procedure of transmitting random access preambles 52 at increasing transmit power levels on physical channel PRACH 201 to base station 14.

In an aspect, at block 306, the method 300 may include determining that the number of random access preamble transmissions exceeds an unacknowledged preamble transmission number threshold N_{threshold}. For example, in an aspect, UE 12 and/or RACH component 30 and/or acknowledgement component 38 in association with one or more processors 20 and memory 62 may count a number of unacknowledged random access preambles 52 (FIG. 2) and determine that the count exceeds the count threshold N_{threshold} 204 (FIG. 2). This threshold count allows UE 12 to perform a predetermined number of attempts of random access preamble transmissions before engagement of additional measures to control wasteful random access preamble transmissions. To implement this process at block 306, receiver 69 of one or more transceivers 60 may monitor downlink channel AICH 202 for a RACH response, while one or more processors 20 with memory 62 may keep a count (e.g., stored in memory 62) of how many random access preambles 52 are transmitted and unacknowledged by a response from base station 14, and compare the count to the threshold N_{threshold} 204 stored in memory 62.

In an aspect, at block 308, the method 300 may include determining whether a downlink channel quality measurement 210 meets a downlink channel quality threshold 212 in response to determining that the number of unacknowledged random access preambles 52 meets the preamble transmission number threshold N_{threshold} 204. For example, in an aspect, UE 12 and/or RACH component 30 and/or downlink quality component 40 in association with one or more processors 20 and memory 62 may determine downlink channel quality based on one or more metrics, such as received signal code power (RSCP), serving cell common pilot channel (CPICH) energy, received signal strength indicator (RSSI), energy per chip/noise spectral density (Ec/Io), combiner lock threshold, uplink interference, uplink RACH power. Referring to FIG. 2, measurement of the downlink channel quality may begin 211 upon the count of unacknowledged preambles reaching N_{threshold} 204, and the downlink channel quality measurement(s) 210 is compared to the downlink channel quality threshold 212. To implement this process at block 308, one or more processors 20 may operate in conjunction with memory 62 to perform quality measurements on a downlink channel received by receiver 69 of one or more transceivers 60, and storing the downlink channel quality measurements 210 in memory 62 for comparison to a stored downlink channel quality threshold 212.

In an aspect, at block 310, the method 300 may include suspending the transmitting of subsequent random access preamble transmissions for transmit hold duration in response to determining that the downlink channel quality does not meet a downlink channel quality threshold. For example, in an aspect, UE 12 and/or RACH component 30 and/or preamble component 36 in association with one or more processors 20 and memory 62 may suspend preamble transmission 55 for the duration T_{hold}_{_}_{threshold} 206 for a current transmission time interval (TTI). The suspension of preambles at 55 may be extended, e.g., based on continued downlink channel quality measurement 210 with failure of the downlink channel quality to meet a downlink channel quality threshold 212 for a duration up to random access stop threshold T_{RACH}_{_}_{threshold} 207. As an example implementation, at block 310, one or more processors 20 may operate in conjunction with memory 62 to track elapsed downlink channel quality failure duration 205 (e.g., TTI's) as measured downlink channel quality 210 remains below downlink channel quality threshold 212 stored in memory 62, while random access preambles 52 are being suspended by one or more processors 20.

In an aspect, at block 312, the method 300 may include sending one or more status messages to a higher protocol layer in response to the suspending of the transmitting of the subsequent random access preamble transmissions, wherein the one or more status messages each indicate that no acknowledgement has been received for the corresponding one of the subsequent random access preamble transmissions that would have been transmitted during the transmit hold duration. For example, in an aspect, UE 12 and/or RACH component 30 and/or response status component 42 in association with one or more processors 20 and memory 62 may be configured to send the one or more status messages to the higher protocol layer in response to the suspending of the transmitting of the subsequent random access preamble transmissions.

In an aspect, at block 314, the method 300 may include determining whether the suspending of the transmitting of the subsequent random access preamble transmissions has lasted for a random access stop threshold. For example, in an aspect, UE 12 and/or RACH component 30 and/or downlink quality component 40 in association with one or more processors 20 and memory 62 may determine that the elapsed downlink channel quality failure duration 205 exceeds the random access stop threshold T_{RACH}_{_}_{threshold} 207. If the downlink channel quality measurement 210 has improved to meet downlink channel quality threshold 212, then method 300 returns to block 304, where the preamble component 36 resumes generation and transmission of random access preambles 52. As an example implementation, one or more processors 20 may operate in conjunction with memory 62 to track the elapsed downlink channel quality failure duration 205 for which measured downlink channel quality 210 remains below the downlink channel quality threshold 212 stored in memory 62, and compare the elapsed downlink channel quality failure duration 205 to a time duration threshold T_{RACH}_{_}_{threshold} 207 stored in memory 62.

In an aspect, at block 316, the method 300 may include ending the PRACH procedure in response to the determining (block 314) that the suspending of the transmitting of the subsequent random access preamble transmissions has lasted for an extended durational the random access stop threshold. For example, UE 12 and/or the preamble component 36 in association with and/or one or more processors 20 and memory 62 may exit the current PRACH procedure 209 upon the elapsed downlink channel quality failure duration 205 reaching threshold T_{RACH}_{_}_{threshold} 207. To implement the process at block 316, one or more processors 20 may operate in conjunction with memory 62 to cease the current PRACH procedure, and reset counter for threshold N_{threshold} stored in memory 62.

In an aspect at block 318, the method 300 may include determining if the degraded downlink channel quality has persisted for an extended durational threshold. For example, in an aspect, UE 12 and/or RACH component 30 and/or downlink quality component 40 in association with one or more processors 20 and memory 62 may determine that the suspended duration of continued failure of the downlink channel quality measurement 210 to meet a downlink channel quality threshold 212 exceeds cell reselection threshold CR_{threshold} 208. If the downlink channel quality measurement 210 indicates that the downlink channel quality measurement 210 has improved before expiration of cell reselection threshold CR_{threshold} 208, then method 300 returns to block 302, where the preamble component 36 awaits a command to commence a new PRACH process for resuming generation and transmission of random access preambles 52. For example, the process at block 318 may be implemented by one or more processors 20 in conjunction with memory 62 to compare downlink channel quality measurement 210 to downlink channel quality threshold 212, and elapsed downlink channel quality failure duration 205 against threshold CR_{threshold} 208.

In an aspect, at block 320, the method 300 may include initiating a cell reselection to a new cell in response to the determining (block 318) that downlink channel quality failure duration, with downlink channel quality sustained below downlink channel quality threshold, has lasted for an extended duration up to cell reselection threshold. For example, in an aspect, UE 12 and/or response cell reselection component 44 in association with one or more processors 20 and memory 62 may initiate a cell reselection at 215 (FIG. 2) to a different cell, such as one served by base station 16. To implement the process at block 320, one or more processors 20 may operate in conjunction with memory 62 to initiate cell reselection signals and transmit the signals via transceiver 60 to base station 14 and base station 16 for switching UE 12 to a different cell in response to determining that the poor downlink channel quality has persisted long enough (CR_{threshold} 208) such that the current cell is not acceptable for the RACH procedure.

As used in this application, the terms “component,” “process,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a process. One or more components can reside within a component and/or thread of execution and a component may be localized on one computer and/or distributed between two or more computers. In addition, these components can execute from various computer readable media having various data structures stored thereon. The processes may communicate by way of local and/or remote components such as in accordance with a signal having one or more data packets, such as data from one component interacting with another component in a local system, distributed system, and/or across a network such as the Internet with other systems by way of the signal.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 12 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. Additionally, base station 14 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

By way of example, various aspects described herein related to random access preamble transmission may be extended to other UMTS and/or LTE and/or other systems where UE has bursty data to transmit which is not suitable for establishing a dedicated channel (e.g., during a forward access channel (CELL FACH) state)). For example, such UMTS systems may include TD-SCDMA, High Speed Downlink Packet Access (HSDPA), High Speed Uplink Packet Access (HSUPA), High Speed Packet Access Plus (HSPA+) and TD-CDMA. Also, such LTE and/or other systems may include Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), application specific integrated circuit (ASIC), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112 (f), unless the element is expressly recited using the phrase “means for” or, in the case of a method claim, the element is recited using the phrase “step for.”

What is claimed is:

1. A method of transmitting data in a user equipment during a random access procedure, comprising:
transmitting, via a transmitter, a number of random access preamble transmissions in response to receiving a command to initiate a physical random access procedure, wherein the number of random access preamble transmissions have not been acknowledged;
determining, via a processor, that the number of random access preamble transmissions meets an unacknowledged preamble transmission number threshold;
determining, via the processor, whether a downlink channel quality measurement meets a downlink channel quality threshold in response to determining that the number of random access preamble transmissions meets the preamble transmission number threshold; and
suspending, at the transmitter, the transmitting of random access preamble transmissions for a transmit hold duration in response to determining failure of the downlink channel quality measurement to meet the downlink channel quality threshold.

2. The method of claim 1, further comprising:
sending one or more status messages to a higher protocol layer in response to the failure of the downlink channel quality measurement to meet the downlink channel quality threshold during the transmit hold duration, wherein the one or more status messages indicate that no acknowledgement has been received for the corresponding one or more of subsequent random access preamble transmissions that would have been transmitted during the transmit hold duration.

3. The method of claim 1, further comprising:
determining whether the failure of the downlink channel quality measurement to meet the downlink channel quality threshold has lasted for a duration of a random access stop threshold; and
ending the random access procedure in response to determining that the failure of the downlink channel quality measurement to meet the downlink channel quality threshold has lasted for a duration of a random access stop threshold.

4. The method of claim 3, further comprising:
resuming the random access procedure in response to the downlink channel quality measurement meeting the downlink channel quality threshold prior to expiration of the random access stop threshold duration.

5. The method of claim 3 wherein the random access stop threshold is set to a duration less than that used for transmitting Preamble Retransmission Max preambles according to 3GPP specifications.

6. The method of claim 1, further comprising:
determining whether the failure of the downlink channel quality measurement to meet the downlink channel quality threshold has lasted for a duration of a cell reselection threshold; and
initiating a cell reselection to a new cell in response to determining that the failure of the downlink channel quality measurement to meet the downlink channel quality threshold has lasted for a duration of a cell reselection threshold.

7. The method of claim 6, further comprising:
restarting the physical random access procedure in response to the downlink channel quality measurement meeting the downlink channel quality threshold prior to expiration of the cell reselection threshold duration.

8. The method of claim 1, wherein the downlink channel quality measurement is based on at least one of received signal code power (RSCP), serving cell common pilot channel (CPICH) energy, received signal strength indicator (RSSI), energy per chip/noise spectral density (Ec/Io), combiner lock threshold, uplink interference, or uplink RACH power.

9. The method of claim 1, wherein the unacknowledged preamble transmission number threshold is set to be less than a maximum count limit Preamble Retransmission Max according to 3GPP specifications.

10. The method of claim 1, wherein the transmit hold duration is a current transmission time interval.

11. A user equipment, comprising:
a processor coupled to a memory; and
a transceiver coupled to the processor, configured to transmit a number of random access preamble transmissions in response to receiving a command to initiate a physical random access procedure, wherein the number of random access preamble transmissions have not been acknowledged;
wherein the processor and memory are configured to determine that the number of random access preamble transmissions meets an unacknowledged preamble transmission number threshold; and determine whether a downlink channel quality measurement meets a downlink channel quality threshold in response to determining that the number of random access preamble transmissions meets the preamble transmission number threshold;
wherein the transceiver is further configured to suspend the transmitting of random access preamble transmissions for a transmit hold duration in response to the processor and memory determining failure of the downlink channel quality measurement to meet the downlink channel quality threshold.

12. The UE of claim 11, wherein the processor and memory are further configured to send one or more status messages to a higher protocol layer in response to the failure of the downlink channel quality measurement to meet the downlink channel quality threshold during the transmit hold wherein the one or more status messages indicate that no acknowledgement has been received for the corresponding one or more of subsequent random access preamble transmissions that would have been transmitted during the transmit hold duration.

13. The UE of claim 11, wherein the processor and memory are configured to :
determine whether the failure of the downlink channel quality measurement to meet the downlink channel quality threshold has lasted for a duration of a random access stop threshold; and
end the physical random access procedure in response to determining that the failure of the downlink channel quality measurement to meet the downlink channel quality threshold has lasted for a duration of a random access stop threshold.

14. The UE of claim 13, wherein the processor and memory are further configured to resume the physical random access procedure in response to the downlink channel quality measurement meeting the downlink channel quality threshold prior to expiration of the random access stop threshold duration.

15. The UE of claim 13 wherein processor and memory are further configured to set the random access stop threshold to a duration less than that used for transmitting Preamble Retransmission Max preambles according to 3GPP specifications.

16. The UE of claim 11, wherein the processor and memory are further configured to determine whether the failure of the downlink channel quality measurement to meet the downlink channel quality threshold has lasted for a duration of a cell reselection threshold; and initiate a cell reselection to a new cell in response to determining that the failure of the downlink channel quality measurement to meet the downlink channel quality threshold has lasted for a duration of a cell reselection threshold.

17. The UE of claim 16, wherein the processor and memory are further configured to restart the physical random access procedure in response to the downlink channel quality measurement meeting the downlink channel quality threshold prior to expiration of the cell reselection threshold duration.

18. The UE of claim 11, wherein the processor and memory are further configured to determine downlink channel quality measurement based on at least one of received signal code power (RSCP), serving cell common pilot channel (CPICH) energy, received signal strength indicator (RSSI), energy per chip/noise spectral density (Ec/Io), combiner lock threshold, uplink interference, or uplink RACH power.

19. The UE of claim 11, wherein the processor and memory are further configured to set the unacknowledged preamble transmission number threshold to be less than a maximum count limit Preamble Retransmission Max according to 3GPP specifications.

20. The UE of claim 11, wherein the transmit hold duration is a current transmission time interval.

21. A computer-readable medium storing computer executable code for controlling uplink transmissions on an enhanced dedicated channel in wireless communications, comprising:
code for transmitting a number of random access preamble transmissions in response to receiving a command to initiate a physical random access procedure, wherein the number of random access preamble transmissions have not been acknowledged;
code for determining that the number of random access preamble transmissions meets an unacknowledged preamble transmission number threshold;
code for determining whether a downlink channel quality measurement meets a downlink channel quality threshold in response to determining that the number of random access preamble transmissions meet the preamble transmission number threshold; and
code for suspending the transmitting of random access preamble transmissions for a transmit hold duration in response to determining failure of the downlink channel quality measurement to meet the downlink channel quality threshold.

22. The computer-readable medium of claim 21, further comprising:
code for sending one or more status messages to a higher protocol layer in response to the failure of the downlink channel quality measurement to meet the downlink channel quality threshold during the transmit hold duration, wherein the one or more status messages indicate that no acknowledgement has been received for the corresponding one or more of subsequent random access preamble transmissions that would have been transmitted during the transmit hold duration.

23. The computer-readable medium of claim 21, further comprising:
code for determining whether the failure of the downlink channel quality measurement to meet the downlink channel quality threshold has lasted for a duration of a random access stop threshold; and
code for ending the physical random access procedure in response to determining that the failure of the downlink channel quality measurement to meet the downlink channel quality threshold has lasted for a duration of a random access stop threshold.

24. The computer-readable medium of claim 23, further comprising:
code for resuming the physical random access procedure in response to the downlink channel quality measurement meeting the downlink channel quality threshold prior to expiration of the random access stop threshold duration.

25. The computer-readable medium of claim 23 wherein the random access stop threshold is set to a duration less than that used for transmitting Preamble Retransmission Max preambles according to 3GPP specifications.

26. The computer-readable medium of claim 21, further comprising:
code for determining whether the failure of the downlink channel quality measurement to meet the downlink channel quality threshold has lasted for a duration of a cell reselection threshold; and code for initiating a cell reselection to a new cell in response to determining that the failure of the downlink channel quality measurement to meet the downlink channel quality threshold has lasted for a duration of a cell reselection threshold.

27. The computer-readable medium of claim 26, further comprising:
code for restarting the physical random access procedure in response to the downlink channel quality measurement meeting the downlink channel quality threshold prior to expiration of the cell reselection threshold duration.

28. The computer-readable medium of claim 21, wherein the downlink channel quality measurement is based on at least one of received signal code power (RSCP), serving cell common pilot channel (CPICH) energy, received signal strength indicator (RSSI), energy per chip/noise spectral density (Ec/Io), combiner lock threshold, uplink interference, or uplink RACH power.

29. The computer-readable medium of claim 21, wherein the unacknowledged preamble transmission number threshold is set to be less than a maximum count limit Preamble Retransmission Max according to 3GPP specifications.

30. The computer-readable medium of claim 21, wherein the transmit hold duration is a current transmission time interval.
